(19) United States
(12) Patent Application Publication
(10) Pub. No.: US 2010/0095348 A1
(43) Pub. Date: Apr. 15, 2010

(54) SYSTEM AND METHOD FOR MANAGEMENT AND TRANSLATION OF TECHNICAL SECURITY POLICIES AND CONFIGURATIONS

(75) Inventors: James C. Foster, Linthicum, MD (US); Andrew Eye, Linthicum, MD (US); Kevin Harriford, Linthicum, MD (US); Lewis Sun, Linthicum, MD (US); Stephen Nason, Linthicum, MD (US); Elbert Vandemark, Linthicum, MD (US); Paul Dant, Linthicum, MD (US)

Correspondence Address: STAAS & HALSEY LLP, SUITE 700, 1201 NEW YORK AVENUE, N.W., WASHINGTON, DC, 20005, US

(73) Assignee: Ciphent, Inc., Linthicum, MD (US)

(21) Appl. No.: 12/249,543

(22) Filed: Oct. 10, 2008

(51) Int. Cl. G06F 9/00; G06F 17/00

(52) U.S. Cl. 726/1; 726/11

(57) ABSTRACT

A system and method translating information of a source policy configuration into a universal data type useable with a target policy configuration. The disclosed system and method provide comprehensive and highly automated translation of security policies and configurations into a normalized format, thereby enabling management and transformation of information across various types of technologies. Normalized data format is utilized to output data into different formats or data types.

### BACKGROUND

1. Field

The embodiments discussed are directed to management of security information; more particularly, to the management and translation of information of a policy configuration related to security application(s) and/or service(s) for universal use.

2. Description of the Related Art

The possibility of attacks on data and system(s) has mandated protection from any suspicious activity that might indicate an attack. The approximately $3.6 Billion “Endpoint Protection” IT security market is comprised of a handful vendors such as McAfee®, Symantec®, and Trend Micro® who command roughly 85% of the market share. Companies who aim to enter the market or gain market share will encounter several barriers to entry, including customers' investment in incumbent technology configuration, as well as high cost and risk associated with transitioning to alternate products and/or solutions, etc.

Generally, the endpoint security industry umbrella encompasses products to include, without limitation: anti-virus, anti-spyware, encryption, data loss prevention (DLP), personal firewalls and host-based intrusion prevention (HIPS). Current attempts at migrations between competing products in the data security industry are costly, leaving users with little evidence that protection under new products matches or exceeds historical protection found in previous products. To compound this problem, these products require hundreds of configuration items (policies) to be set and adjusted based on the specific needs and network infrastructure existing at each client installation. To date, the migration from one product or suite to a competing product or suite has been based almost entirely on manual processes executed by vendors, reseller field engineers, etc., and often includes using existing policy configuration sets in one product as a baseline for establishing policies in a replacement or displacement product.

In addition to the abovementioned problems of high cost and labor associated with typical migration techniques, the manual nature of current removal, installation, and implementation processes introduces the risk of human error into the transfer of policy configurations between products. Vendors generally do not have established guidelines for mapping policy configurations between competing products and tend to rely on the expertise of individual field engineers to accurately transition established, working policies. Failure by a single field engineer to correctly deploy and configure products can lead to network outages, malware exploitations, and dissatisfied customers. Since successful implementation of security software is key to software security product vendors' success, the element of human error also begets increased average costs and timelines, as successful implementation is often not accomplished by junior field engineers.

As foreshadowed by the above-identified disadvantages, the time required for deployment completion and current migrations can take from months to over a year to execute, largely due to the time required to review and map policy configurations between products. Moreover, current migration techniques require highly trained, expensive resources with expert knowledge in all popular products from various vendors.

Adding to the confusion and difficulty faced by field engineers, policy definition formats and types of configuration information can vary drastically among vendors. Various types of security solutions provided by different vendors may be utilized to secure data.

In light of the above and other concerns, there is a need for both a method and system that enable management and portability of security policies and configurations across different security solutions.

### SUMMARY

It is an aspect of the embodiments discussed herein to provide a system and method capturing information of a source policy configuration and translating that information into a universal data type useable with a target policy configuration.

The disclosed method and system is enabled to transform information of a source policy configuration into a set of normalized data elements, map the set of normalized data elements into values for a given number of target policy configuration file(s), and generating those files based on the source policy configuration's content.

It is an aspect of the embodiments discussed herein to provide a computer-readable medium containing a program for causing a computer to execute operations, including retrieving a policy configuration file of a first security application, transforming a value of the policy configuration file to a normalized field via an adapter, creating a new policy configuration file based on the normalized field via an adapter and using the new policy configuration file with a second security application based on the policy file of the first security application.

The disclosed system and method provides comprehensive and highly automated translation of (a) system security policy configuration(s) into a normalized data element(s) and uses the normalized data element(s) to output data into different system formats without requiring expensive user analysis and instruction.

Additional aspects and/or advantages will be set forth in part in the description that follows, and in part will become more apparent from the description, or may be learned by practice of the invention.

### BRIEF DESCRIPTION OF THE DRAWINGS

Reference will now be made in detail to the embodiments, examples of which are illustrated in the accompanying drawings, wherein like reference numerals refer to the like elements throughout. The embodiments are described below to explain the present invention by referring to the figures.

FIG. 1 illustrates a block diagram of a system configured to perform management and translation of policy configuration(s) and configuration information.

FIG. 2 illustrates a flowchart for translating and mapping information of a source policy to a specified output format.

FIG. 3 illustrates a flowchart for creating a new policy file based on content of an original policy file.

FIG. 4 illustrates a translation path from a source policy to an output policy.

FIG. 5 illustrates a graphical user interface (GUI) providing customizable data summaries and tool(s).

FIG. 6 illustrates a GUI for converting a source policy of a product to a policy of a destination product.

FIG. 6A illustrates a GUI for converting a source policy to a policy of any designated vendor.

FIG. 7 illustrates a GUI for selecting (an) adapter(s) enabling access to configuration information across multiple products.

FIG. 7A illustrates a GUI for managing adapter(s) enabling access to policy configuration information of product(s).

FIG. 7B illustrates a GUI for creating a new adapter.

FIG. 7C illustrates a GUI for editing information of adapters.

FIG. 8 illustrates a GUI for providing a policy catalog.

FIG. 9 illustrates a flowchart for translating information of a source policy to a universal file type.

FIG. 10 illustrates a GUI for converting information of an input product to an output product.

FIG. 11 illustrates a layout of normalized and brand policy items.

FIG. 11A illustrates a GUI for managing normalized data fields.

FIG. 12 illustrates a record of managing and/or translating policy items.

FIG. 13 illustrates a GUI for creating a new compliance standard.

FIG. 13A illustrates a GUI for editing a compliance standard.

FIG. 13B illustrates a GUI for managing information of compliance standard(s).

FIG. 14 shows a GUI for running a healthcheck.

FIG. 15 shows a GUI for managing information of users.

### DETAILED DESCRIPTION OF THE EMBODIMENTS

Reference will now be made in detail to the present embodiments discussed, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

To overcome drawbacks of known security tools, services and products, the disclosed system and method translates policy configuration(s) for use across different security solutions. The system and method provide comprehensive and highly automated translation of system security policies and configurations for technologies related to antivirus, antispyware, host intrusion prevention, host-data loss prevention application, host firewalls, patch management, vulnerability management, configuration management, endpoint and system encryption, data security, data tagging and sensitive information control, and compliance management into a normalized format. Such normalized format is utilized to output data into different system formats. The system and method require minimal human analysis and instruction.

A policy configuration may be any information controlling a software, service, or product that is running on a device including—in relation to operation(s)—prevention of unauthorized activity such as antivirus software, antispyware software, a firewall, etc. but not limited thereto, and/or defining configuration of an application, tool or service including prevention of damage and/or intrusion to user applications, files, networks, and hardware. The terms “policy configuration” and “policy file” or “information” are interchangeably used herein. A policy configuration item, object or element may be an attribute of a policy configuration, information or file used to implement particular operation(s), define settings of any type of system resource(s) to include/exclude protective scan(s), detection process(es) including filesystems, drives, memory, removable media, bootable devices and network resources, define preferences that describe sub-sections thereof including, but not limited to applications, application behaviors, filenames, filetypes, locations and/or portions of memory.

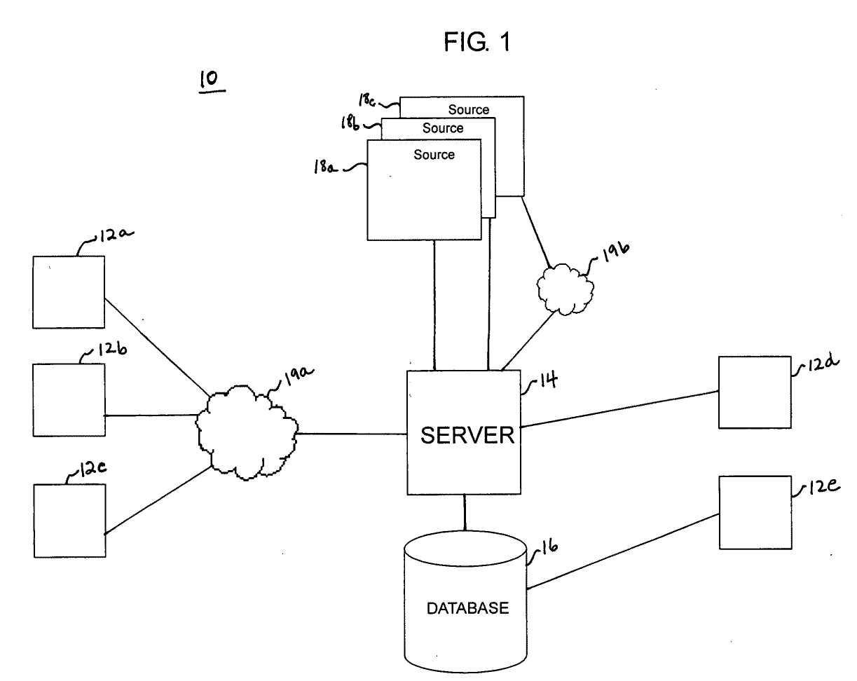

FIG. 1 illustrates system 10 translating (or transforming) information of a policy configuration of a product or service to a universal data type useable with another product or service. As shown in FIG. 1, the system 10 may include devices 12a, 12b, 12c connected with a server 14 via a network 19a, and sources 18a, 18b, 18c and devices 12d, 12e connected with the server 14.

The sources 18a and 18b communicatively coupled to the server 14 and the source 18c connected with the server 14 via a network 19b provide information of policy configuration defining operations of corresponding products and/or services to the server 14. For example, the source 18a may be a vendor of a product supplying information of (a) policy file(s) and configuration information of a particular product developed by the vendor. However, the system 10 is not limited to obtaining policy file(s) or configuration information from a particular source and may obtain the file(s) and/information, for example, from third parties that manage information on behalf of a vendor, or from a manufacturer.

The sources 18 may also provide maintenance and updates of software and/or services from a manufacturer, a distributer and/or non-affiliated organizations including access information specifics not limited to username, password, and path to resources, as well as a frequency of update availability and action(s) to take based upon the availability.

The devices 12a, 12b, 12c, 12d and 12e are devices or systems that have installed thereon an application, a tool or service for securing, managing or updating data. The devices 12 may be a server, personal computer, a laptop computer, a specialized terminal, a handheld or portable device, etc. For example, the devices 12 may be devices utilized by end users in an individual or networked environment. Although a number of devices 12 are illustrated in FIG. 1, the present invention is not limited to any particular type or number of devices. The system 10 may be implemented to manage a security product and/or service installed on enterprise systems, workstations and/or servers.

In the situation where one of the devices 12 (FIG. 1) runs more than one security application or service, the system 10 enables a user to switch from one product that may be ineffective or defective to another product by using, for example, a universal data type to create a policy configuration for using another security application.

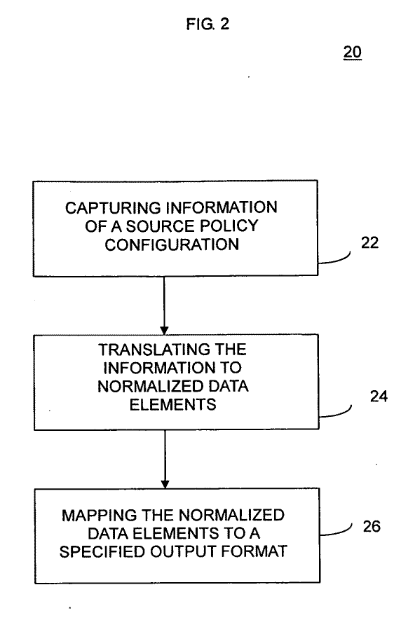

The server 14 captures information of a source policy configuration or file of a product, software, or service from one or more of the sources 18 and translates the information into a universal data type useable with a target policy configuration or file. For example, the server 14 obtains a policy configuration from the source 18a defining setting information of a product provided by a particular vendor and translates the information for use with a product provided by another vendor who uses a format different from the initial vendor to configure the product. Operation(s) of the server 14 is explained in detail below with respect to FIGS. 2, 3 and 4.

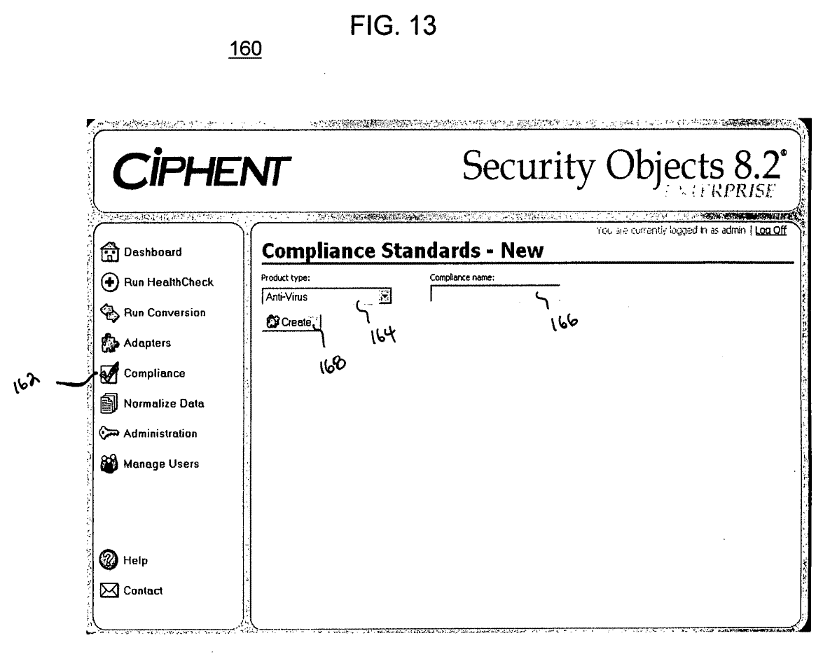

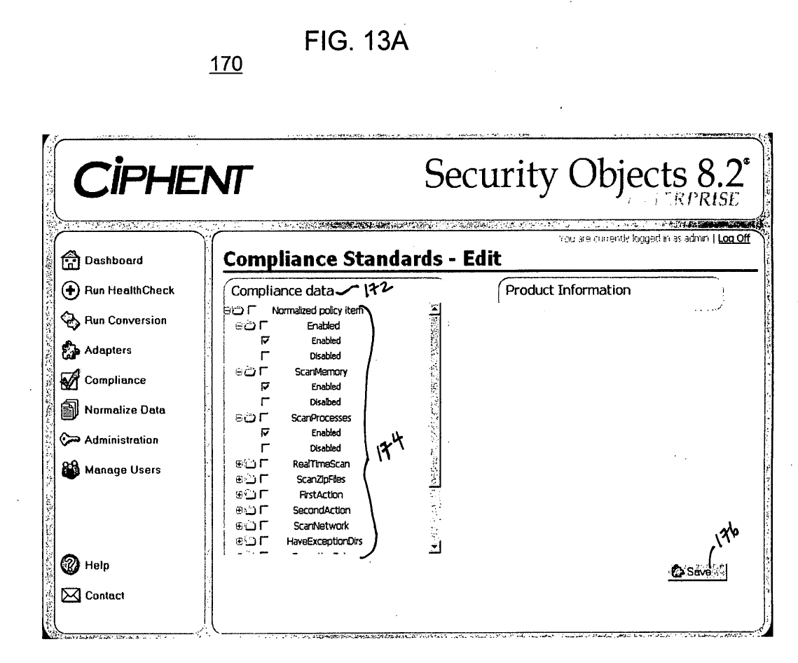

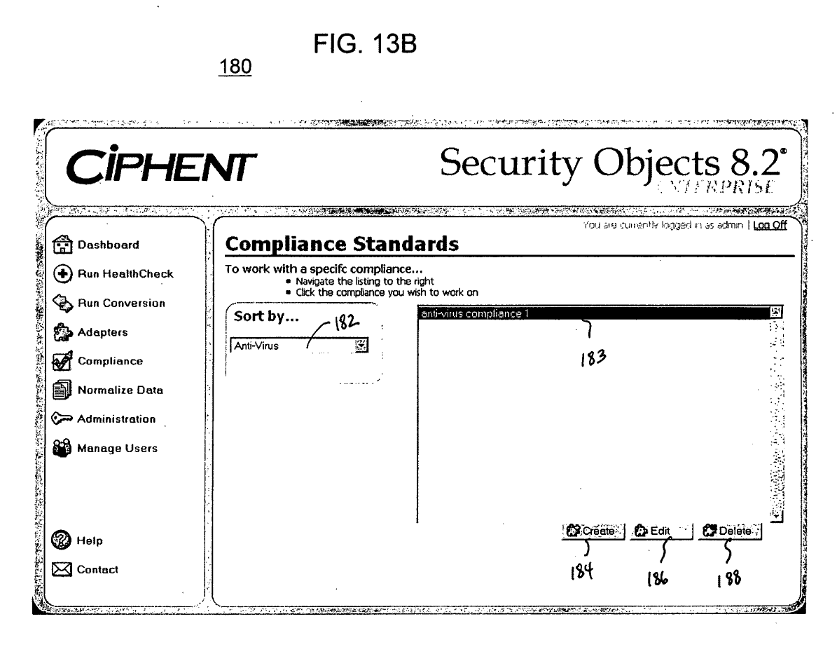

The server 14 is configured to ascertain that devices are properly protected by keeping up-to-date with policy files and configuration information of different products and/or services and implementing a compliance management. For example, a periodic update may be obtained from one or more of the sources 18 to update information of policies and configurations in a library stored in the database 16. As such, the system 10 operates as middleware that is enabled to communicate with any security product, application, solution or service on an endpoint system, including when said products are dissimilar. Compliance management operation(s) is/are explained in detail below with respect to FIGS. 13, 13A and 13B.

The server 14 may provide a notification to a user or an administrator including common methods/techniques such as centralized and distributed notification, SNMP, SMTP or email, syslog, text messaging, on-screen indicators, file logging, and dialog windows not limited to simple Boolean values, but also conditional preferences and escalation procedures including message recipients, the details to be included in an alert, and names, locations, sizes, quantity, rotation and encryption of notification and/or log data.

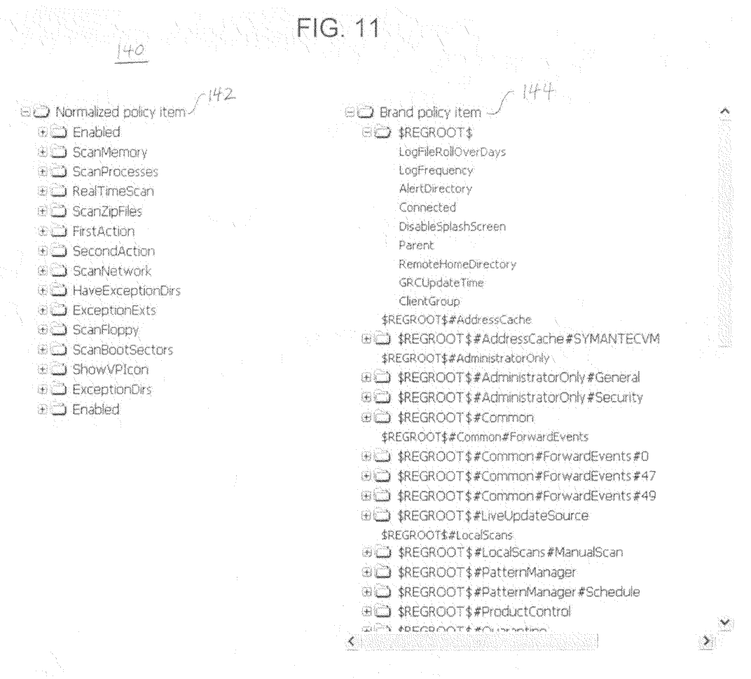

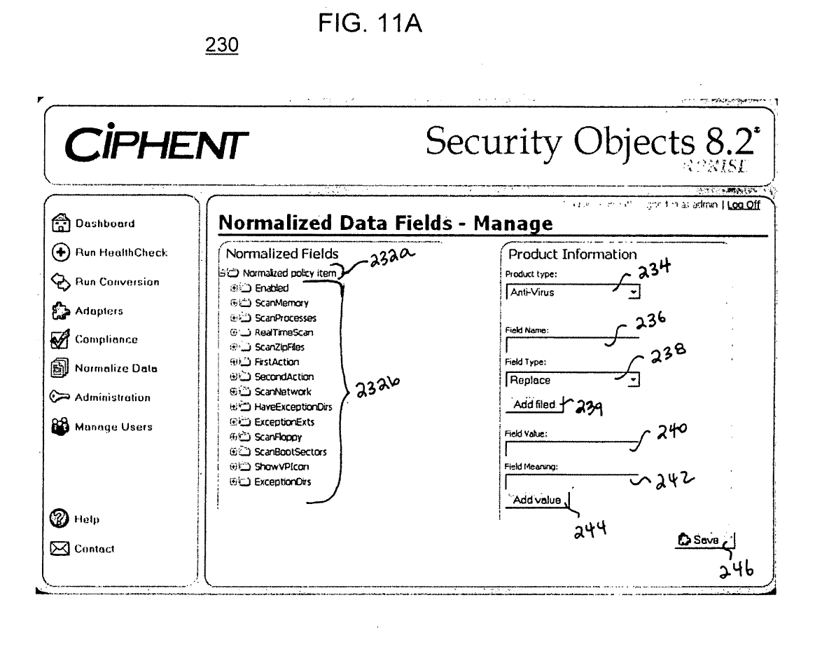

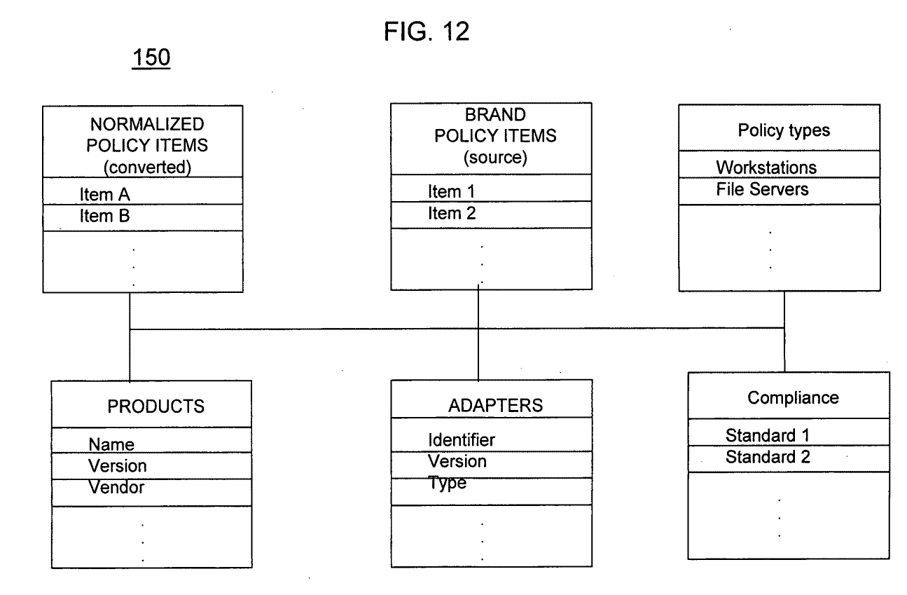

The database 16 stores data pertaining to policy files and configuration information. As mentioned above, data defining policies and configurations of a product may be provided from one or more of the source 18 (FIG. 1). The database 16 may include a library of policy files and configuration information stored, for example, as a relational database. An exemplary content of the database 16 is discussed below in detail in association with FIGS. 11, 11A and 12. Any standalone or networked device capable of storing and processing information may be used to store the policy files and configuration information.

Although FIG. 1 illustrates the server 14 and the database 16 as being separate components, the present invention is not limited to a particular configuration. For example, the server 14, the database 16 and the sources 18 may be provided as one element of the system 10 shown in FIG. 1 without departing from the scope of the invention.

FIG. 2 illustrates process 20 for translating and mapping information of a source policy to a specified output format. As shown in FIG. 2, process 20 begins by capturing 22 information of a source policy configuration. Information of a source policy configuration may be obtained from one or more of the sources 18 (FIG. 1) and may include various types of network, service, software, process, or hardware values, system resources, protocol rules, standards, etc. For example, host and/or network environment values to include system path information, installed software, installation, operating system, and hardware specifics and/or information about system resources, may be captured as a source policy configuration.

The captured 22 source policy may also include resource definitions including but not limited to protective scans and detection methods, file systems, drives, memory, removable media, bootable devices, preferences, application behaviors, filenames, file types, locations, path information, etc.

Subsequent to capturing 22, the process 20 moves to translating 24 the information to normalized data element(s). During the translating 24, an item of a policy configuration is processed and transformed or converted into an item or an object in a given form. For example, the translating 24 may include comparing items of a source policy and a target policy and transforming the item of the source policy into a form useable by the target policy. The translating 24 may be implemented, for example, using .NET, Java®, and/or other solutions using which instances can be converted to be in a consistent form. Normalized data elements are not product or vendor specific and can include without limitation configuration, security settings, and policy information.

After the process 20 translates 24 the information, the process 20 proceeds to mapping 26 the normalized data elements to a specified output format. The mapping 26 includes creating data element association between two distinct data models. For example, the normalized data elements may be associated with any output format such as but not limiting to an extensible Markup Language (XML), ini files, text files, SQL statements, and registry settings.

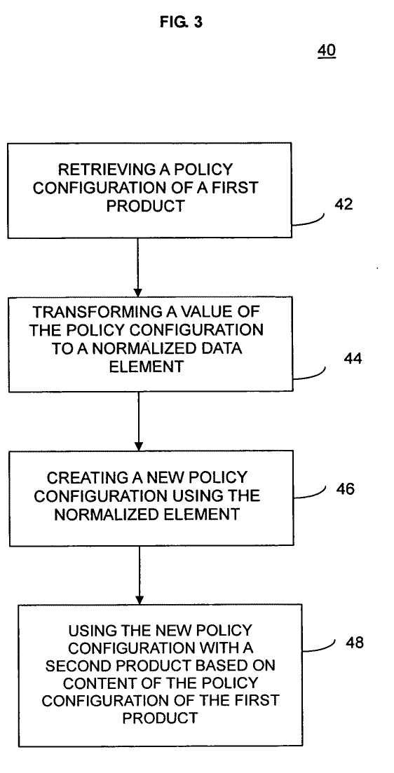

FIG. 3 illustrates a process 40 for creating a new policy configuration based on an original policy configuration. As shown in FIG. 3, process 40 begins by retrieving 42 a policy configuration of a first product. A policy configuration may be retrieved 42 from source(s) 18 (FIG. 1) which may be a vendor of the product, a third party affiliate of the vendor, and/or a policy configuration or file may be retrieved 42 from a library in a database such as the database 16 (FIG. 1) or a separate database to which the system 10 is communicatively coupled, etc. As mentioned above, the policy configuration may include item(s) and/or configuration information defining one or more operations to be executed by a product. The policy configuration retrieved 42 may define all or some of operations and/or processes executable by a particular product. For example, a subset of policy items shared among multiple policy configuration files may be retrieved 42.

The policy configuration retrieved 42 is not limited to any particular data type or format. For example, a policy configuration may be in an extensible markup language (XML), or any other policy format defining operations of a product, application, or service used by a vendor.

Subsequent to retrieving 42, process 40 continues to transforming 44 a value or an item of the policy configuration to a normalized element or field. The value or item of a policy configuration may include any content of the policy configuration including host and/or network environment values, system path information, installed software, installation, operating system, hardware specifics and/or information about system resources, etc. However, the present invention is not limited to transforming a particular value or an item of a policy configuration and may include any item set in the policy configuration to define one or more operations of the product or application. For example, a value or item of a policy configuration may relate to frequency and behavior of an antivirus scan, detection operations including scheduling, timeout, retry, on-access or real-time protections, and depth of detection with regard to heuristics and/or signature confidence, etc.

For example, for an antivirus product, normalized data may include elements such as Enabled, ScanMemory, ScanProcesses, RealTimeScan, ScanZipFiles, FirstAction, SecondAction, ScanNetwork, HaveExceptionDirs, ExceptionExts, ScanFloppy, ScanBootSectors, ShowVPIcon, ExceptionDirs, etc.

After transforming 44 a value of the policy configuration, process 40 proceeds to creating 46 a new policy configuration using the normalized data element. The new policy configuration is created based on content and values of the policy configuration of the first product. For example, an object related to scheduling a virus scan using a first security product is retrieved and used to specify the scheduling using a new policy configuration useable with a second security product, or service.

Subsequent to creating 46 the new policy configuration, process 40 moves to using 48 the new policy configuration with a second product based on content of the policy configuration of the first product. For example, content of a policy configuration defined by a vendor such as Symantec® is used to define value(s) or item(s) defining operations and processes and utilized with another vendor such as McAfee®.

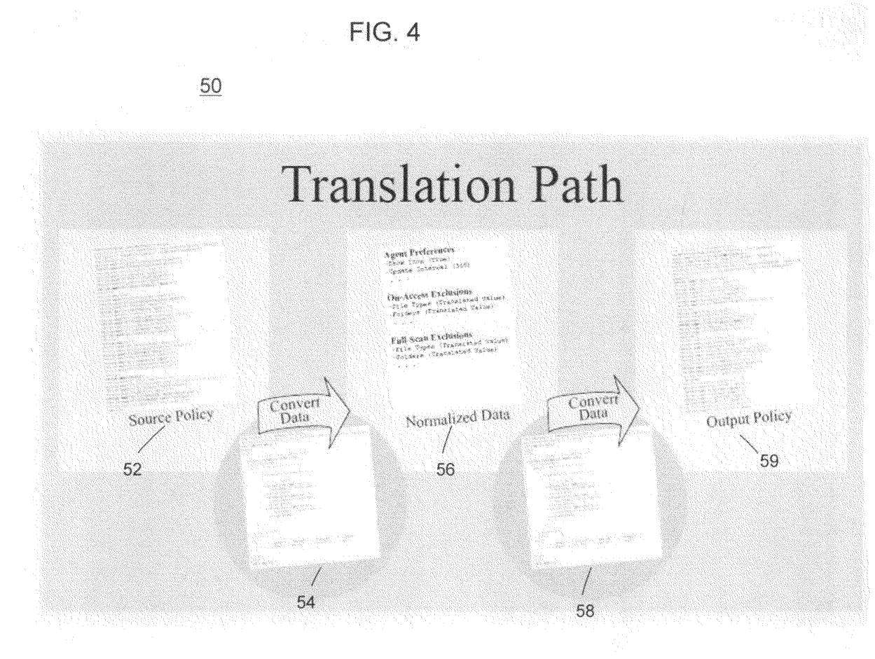

FIG. 4 illustrates a translation path 50 from a source policy to an output policy. As shown in FIG. 4, a source policy 52 of a product is transformed or converted 54 to a normalized data 56 which is converted 58 to an output policy 59. For example, data of a source policy of a given security product may be in an extensible markup language (an XML file) which is converted to a set of normalized data, for example, using extensible stylesheet language transformations (XSLT). Then, the normalized data is converted to an output policy for a different product based on the content or data of the source policy.

Once item(s) and value(s) of the source policy 52 have been converted to the normalized data 56, the content can be stored in the database 16 (FIG. 1) in a generic form, with values that are easily translated to a specific product as needed. These conversions can also be used in a reverse manner, enabling the generation of a policy configuration based on the normalized data. Once the source policy 52 is converted to the normalized data 56, the normalized data may be mapped to item(s) of policy configuration information of a product. Alternatively, a policy file may be generated based on the normalized data 56. In this manner, any type of file that can be mapped and translated can be used as the source and/or output, allowing for conversion of one product-specific policy configuration to the policy format of another product.

Although the translation path 50 is discussed using a policy configuration information in XML and transformed or converted using XSLT as an example, the present invention is not limited to transforming or managing a policy configuration in any particular language. For example, for policy configurations that do not use XML, additional text manipulation and parsing is performed using a variety of string manipulations, ranging from basic to complex, as well as RegEx-style testing of conditional formatting.

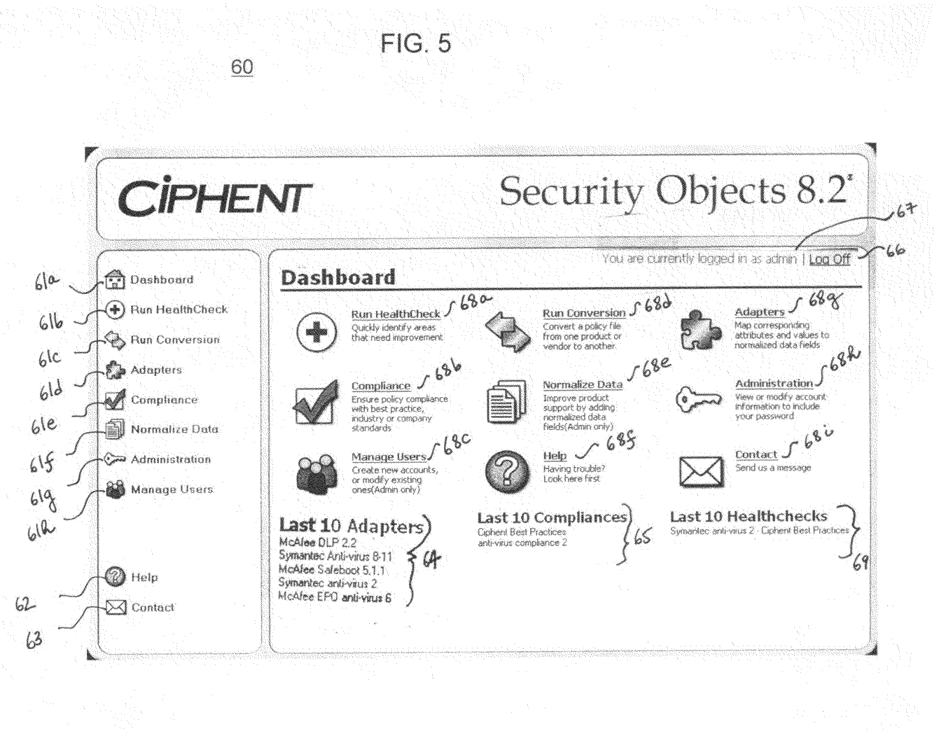

FIG. 5 illustrates a Graphical User Interface (GUI) 60 providing customizable data summaries and tool(s). As shown in FIG. 5, GUI 60 includes selectable options (tools) 61, a help option 62, a contact option 63, and indicators 66 and 67 respectively providing a login and status information. The selectable options 61 include a dashboard option 61a, a run health check option 61b, a run conversion option 61c, adapters option 61d, a compliance option 61e, a normalize data option 61f, an administration option 61g and a manage users option 61h. In FIG. 5, the dashboard option 61a has been selected and a variety of customizable data summaries 64, 65 and 69, and selectable options 68 are shown as a result of the selection.

The customizable data summaries 64, 65 and 69 provide information pertaining to adapters, compliances and healthchecks. For example, as shown in FIG. 5, data summary 64 indicates the last 10 adapters utilized by the system 10 (FIG. 1), while data summaries 65 and 69 indicate the last 10 compliances and healthchecks used, respectively. Although, the data summaries 64, 65 and 69 are illustrated with particular type of data in FIG. 5, the invention is not limited thereto. Further, a system administrator or a user having privileges may set the GUI 60 to display various types of data including newest policies, adapters, compliances, etc., or the system 10 (FIG. 1) may automatically determine commonly used selectable options (tools) and display the same via the GUI 60. Further, the information may include recent usage information, product announcements, security bulletins, general news from the data security industry, etc.

Although specific user interfaces are illustrated in FIG. 5, the present invention is not limited to any particular type of a user interface. For example, the selectable options 61 may be provided as a menu option using which a particular option can be selected. Further, appearance of a user and/or administration interface(s) and personal preference(s) for menus, reports, summaries etc., may be modified within the scope of the present invention.

The compliance option 61e may be used to compare settings/values within a policy to any one of a collection of relevant standards, such as a general standard, or PCI compliance, etc. Based on such a comparison, the system 10 (FIG. 1) may indicate or highlight information such as differences between a user's policy and another policy that aligns with a given standard. The compliance option 61e provides reporting and/or display of information regarding policy coverage, enforcement, and compliance of the security software, or service, etc. As such, the system 10 (FIG. 1) may be used to maintain a security posture among multiple products and/or services. A policy set of products may be obtained from the database 16 (FIG. 1), where a subsection or an entire policy set is pulled out to determine a security posture by comparing the subsection or the entire policy set of across multiple products. For example, a policy item of a product or service pertaining to scheduling of virus scans can be compared with policy item(s) of other product(s) to determine compliance of a standard across multiple products including products developed by different vendors. Operation(s) in relation to the compliance option 61e are discussed in detail below with respect to FIGS. 13, 13A and 13B.

As mentioned above, the disclosed system 10 is enabled to execute a displacement operation where the system 10 takes policies and configuration information from one product to another by mapping similarities of items or objects. Further, the compliance option 61e may be utilized to determine conformance of a policy file or configuration of a product to a standard, ‘best practices’, and/or regulation. In addition, the system 10 (FIG. 1) may obtain policy configuration information from a vendor, map the policy configuration information to normalized data elements and develop a standard, “best practice” or regulation for a particular type of service or product including products provided by the vendors. As such, the system 10 (FIG. 1) may provide a report indicating differences/similarities between policies and/or may generate a baseline policy based on the comparison between two polices, configuration, services, or products.

The manage users option 61h shown in GUI 60 enables basic administration of users, systems and privileges associated therewith. For example, a user may have the ability to update the user information (such as user name, password, email address, etc); however, only a user with administrative privileges would be able to alter permissions and/or other users' information. The manage users option 61h may be utilized to monitor system resources, permissions, execution and/or instantiation of any application into a memory and specified and relevant procedures and practices thereof. Although specifics management operation(s) are discussed, the present invention is not limited to managing any particular data or operation. For example, the manage users option 61h can be implemented to filter network traffic applications including stateful and stateless solutions, application identification, and protocol specific rules and/or policies, and the enforcement and applicability thereof.

The GUI 60 may also include a help option 62 for obtaining assistance or documentation regarding management and/or translation of policy configurations and configuration information and a contact option 63 for providing contact information.

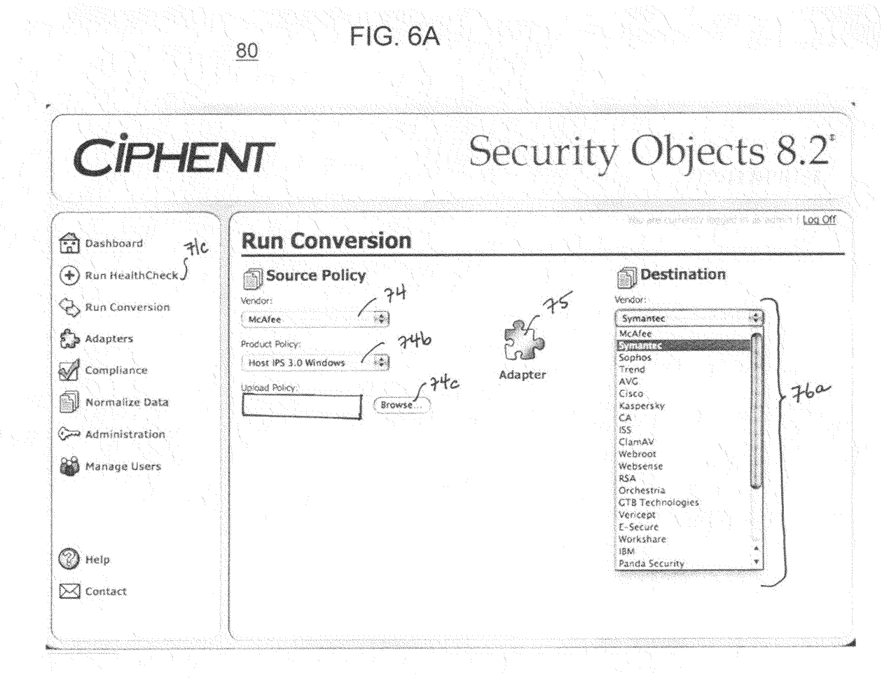

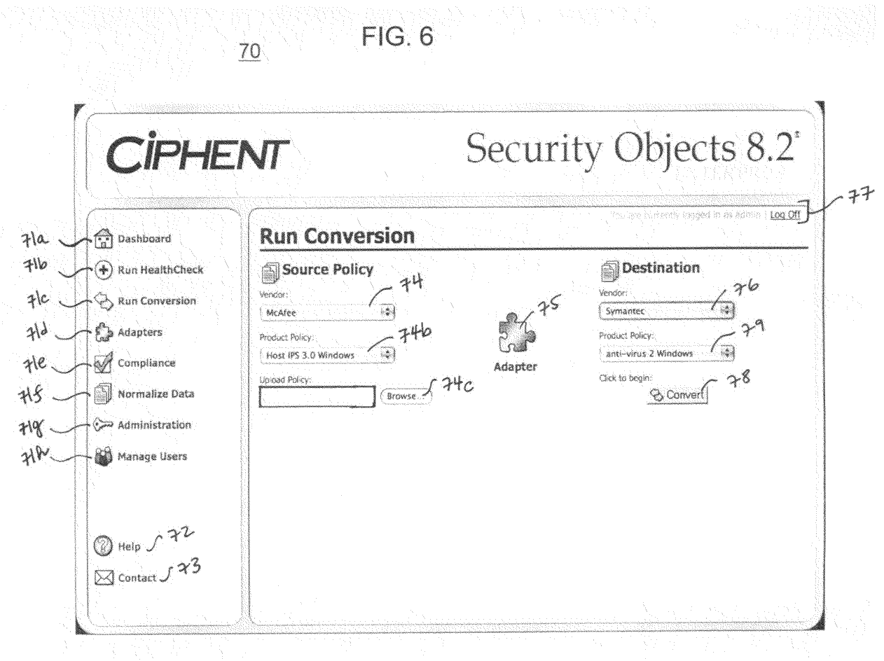

As shown in FIG. 5, the GUI 60 provides selectable options (tools) to run a healthcheck 68a for identifying configuration areas (or items) that need improvement, to implement compliance 68b for ensuring policy compliance with best practice, industry or company standards, and manage users 68c including information of users. The GUI 60 includes the conversion option 68d for converting a policy file from one product or vendor to another, normalize data option 68e for product support including by adding normalized data field(s), help option 68f for requesting assistance, adapters option 68g for mapping corresponding attributes and values to normalized data fields, administer option 68h for managing account information including viewing or modifying account and contact option 68i for obtaining pertinent information. The selectable options or utilities 68 are discussed below in detail with respect to FIGS. 6, 7, 11, 13, 14 and 15.

FIG. 6 illustrates a GUI 70 for converting a source policy of a product to a policy of a destination product. As shown in FIG. 6, the GUI 70 may include selectable options 71 including a dashboard option 71a, a run health check option 71b, a run conversion option 71c, adapters option 71d, a compliance option 71e and a normalize data option 71f, an administration option 71g and a manage users 71h option. The GUI 70 includes a help option 72, a contact option 73, and indicator 77 that displays a login status and an option to logoff. FIG. 6 illustrates the run conversion option 71b selected where options for selecting a source policy, an adapter and a destination are displayed.

Using the GUI 70, a source policy may be selected by indicating a vendor 74, a product policy 74b or by uploading a policy using a browse option 74c, and an adapter may be selected using an adapter selector 75 for converting the source policy to a destination policy by identifying a vendor 76 and a product policy 79. For example, as illustrated in FIG. 6, a user may specify McAfee® as the vendor of a source policy, “Host IPS 7.0 WIndows” as the product policy, and select Symantec®, as the vendor of the destination policy and “anti-virus 2 Windows” as the product policy of the destination. Once the source and destination policies are selected, a user may select a convert option 78 to trigger conversion of policy configuration information of McAfee® to information useable with Symantec®.

FIG. 6A illustrates a GUI 80 for converting a source policy to a policy of any designated vendor. Similar to FIG. 6, the GUI 80 of FIG. 6A includes options for selecting a vendor 74, a product policy 74b, an adapter 75 and a browse option 74c for uploading a policy. As shown in FIG. 6A, option 76a may be used to select any one of multiple vendors as a destination to which the source policy is converted. As shown in FIG. 6A, the GUI 80 provides a list of multiple vendors 76a that a user may select from as a destination to which the source policy is converted. For example, “Host IPS 7.0 Windows” identified as the product policy may be selectively converted to a policy of any one of the multiple vendors by selecting a vendor via the option 76a. Policy information of a vendor selected via the option 76a may be obtained from the sources 18 (FIG. 1), directly supplied by each of the vendors periodically or as requested, obtained from third-parties that manage information on behalf of the vendors, etc.

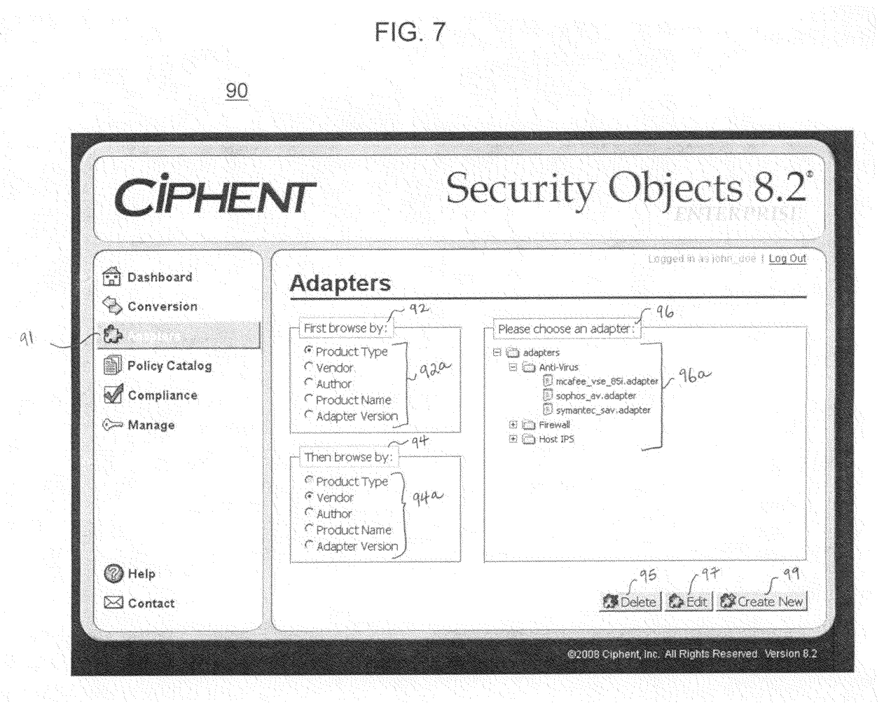

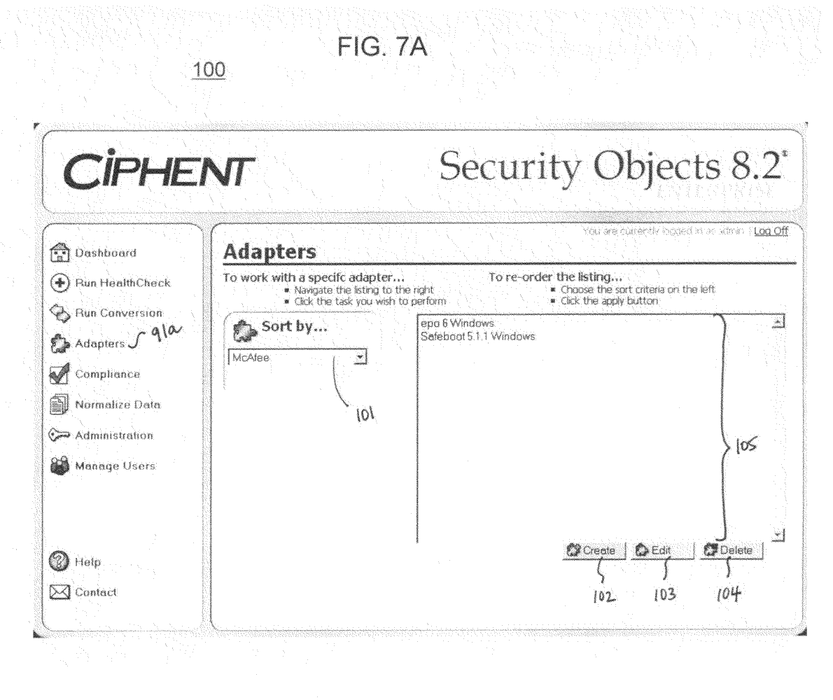

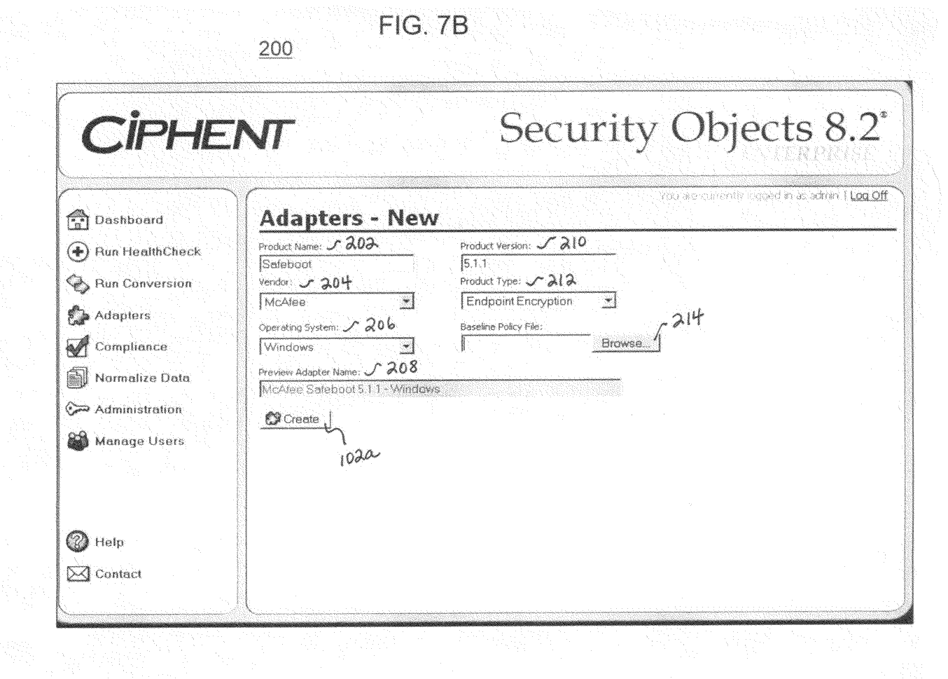

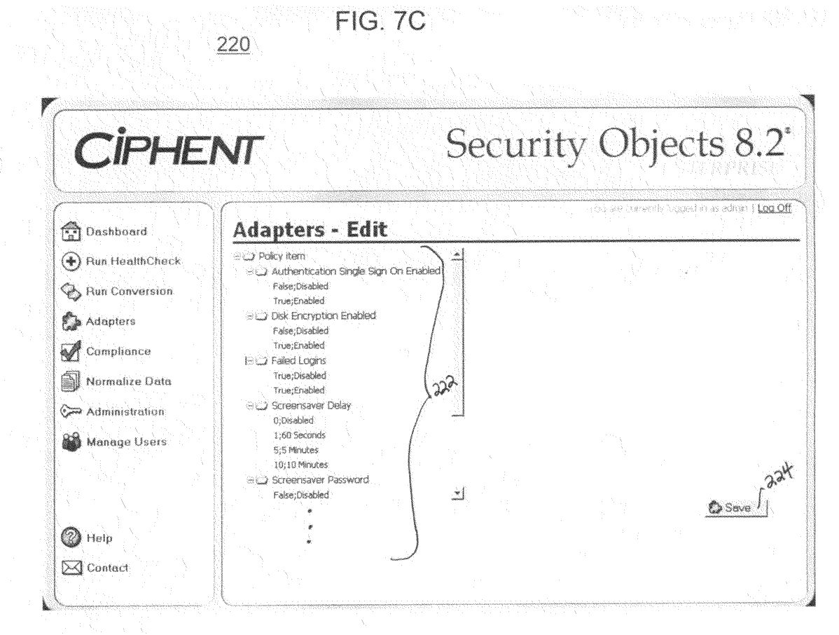

FIG. 7 illustrates a GUI 90 for selecting adapter(s) that enable access to policy configuration information across multiple products. As shown in FIG. 7, GUI 90 includes an adapters selection option 91 allowing a user to choose from a first option 92 for initially browsing through adapters by choosing from selections 92a such as a product type, a vendor, an author, a product name, an adapter version, etc. and a second option 94 for specifying a subsequent browsing information 94a such as a product type, a vendor, an author, a product name, an adapter version, etc.

The GUI 90 includes an option 96 for choosing from a variety of adapters 96a by selecting from among a category of adapters stored in the database 16 (FIG. 1). For example, a user may use the option 96 to choose an adapter specific to a particular antivirus software, a firewall, etc.

A user may select a delete button 95 for deleting information, an edit button 97 to make changes information, and a create new button 99 for creating new information.

The adapters selection option 91 may be used to cause elements to interoperate including dissimilar elements from different vendors or developers. For example, input adapters may be used to specify any of the elements of a first product for mapping to elements that correspond to another product using the input adapters. The adapters in the system 10 (FIG. 1) enable a solution that provides full data access and APIs to various applications including any application developed by a particular vendor that defines configuration information different from other vendors. For example, a user using Symantec® can specify elements of the Symantec® application correspondingly converted to elements of McAfee®.

FIG. 7A illustrates a GUI 100 for managing adapter(s) that enable access to policy configuration information of product(s). The GUI 100 illustrates an adapters option 91a selected for managing or working with a specific adapter. An adapter may be selected by using a sort option 101 for navigating through available adapters using information pertaining to an adapter. For example, adapters may be sorted by identifying a corresponding vendor, product type, author, adapter version, etc. When a sort option 101 is selected using the GUI 100, a list 105 satisfying the sort criteria is provided. For example, “epo 6 Windows” and “Safeboot 5.1.1 Windows” are listed as meeting “McAfee” as the sort criteria. Further, using the GUI 100, a user may delete information via a delete button 102, modify information via an edit button 103, and create (or input) information using a Create New Button 104.

FIG. 7B illustrates a GUI 200 for creating a new adapter. As shown in FIG. 7B, the GUI 200 includes options for inputting information of a new adapter including a product name 202, a vendor 204, an operating system 206, a product version 210, a product type 212, and provides an option for previewing an adapter name 208. The GUI 200 also includes a Browse option 214 for navigating through and selecting a baseline policy file based on which the new adapter may be created and a Create button 102a for creating the new adapter. For example, item(s) of a policy of a particular product may be identified as basis for defining item(s) of a new adapter useable for converting policy information of one product to policy information of another product. The individual adapter fields are edited on FIG. 7C that is presented after submitting for the new object.

FIG. 7C illustrates a GUI 220 for editing information of adapters. As shown in FIG. 7C, the GUI 220 includes information 222 of an adapter that may be edited. Information 222 of an adapter includes all technical information required to map a policy configuration to/from an adapter, which may be selected and edited via the GUI 220. The GUI 220 also includes a save button 224 for saving or storing edited information of an adapter.

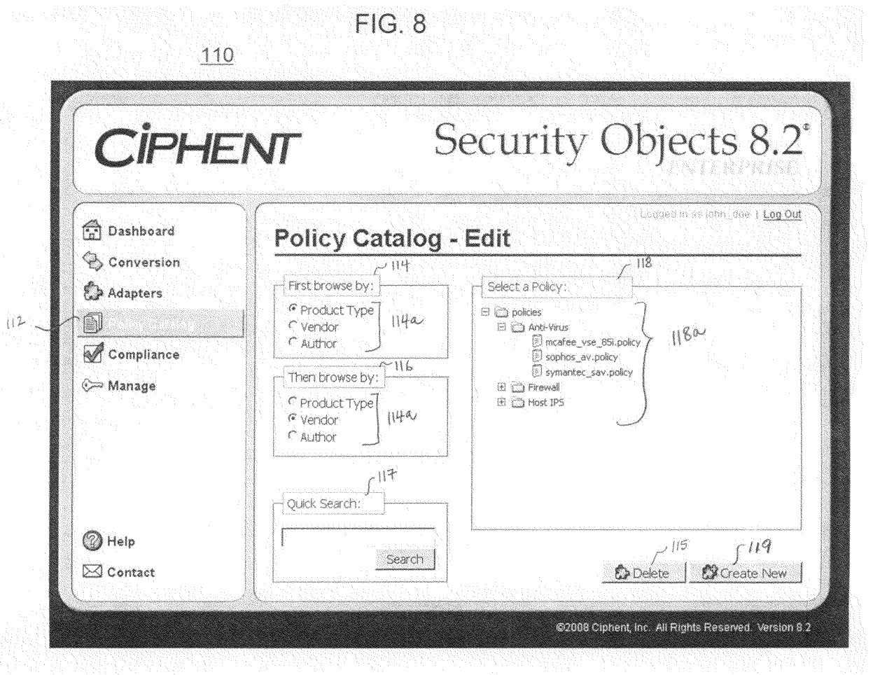

FIG. 8 illustrates a GUI 110 for providing a policy catalog. A policy catalog is a library of policies to which a user has access. The GUI 110 includes a policy catalog option 112 for managing policies and configuration information. As shown in FIG. 8, the GUI 110 includes a first option 114 for initially browsing through catalog information using selectable options 114a such as a product type, a vendor, an author, etc. and a second option 116 for specifying subsequent browsing information 114a such as a product type, a vendor, an author, etc. The GUI 110 also includes a quick search option 117 enabling entry of information of a policy configuration and searching for the policy configuration among various policy configurations.

The policy catalog may be stored in the database 16 (FIG. 1) and serves as a holding area for policies that have been uploaded and/or converted. For example, when a user selects the policy catalog option 112, the user is provided with files uploaded by the user, or a policy converted based on a supplied policy. Information of policies for any product can be uploaded and stored within the policy catalog.

As shown in FIG. 8, the GUI 110 also includes a policy selector 118 providing information of policies 118a for enabling a user to select a specific policy from among various policies. The information of policies 118a may be arranged in categories. For example, as illustrated in FIG. 8, policies may be arranged in categories such as anti-virus, firewall, host IPS, etc. However, information provided when a user selects a policy selection 118 is not limited to any particular arrangement and may include, for example, a sequential listing of policies as defined by an administrator including based on activities such as host intrusion prevention, patch management, vulnerability management, configuration management, endpoint and system encryption, etc.

Information of the policy catalog provided via the GUI 110 may be modified using a delete option 115 for removing information of a policy configuration or create new option 119 for creating a new policy. For example, a new policy may be created by an administrator based on effective usage of a policy across various products or services.

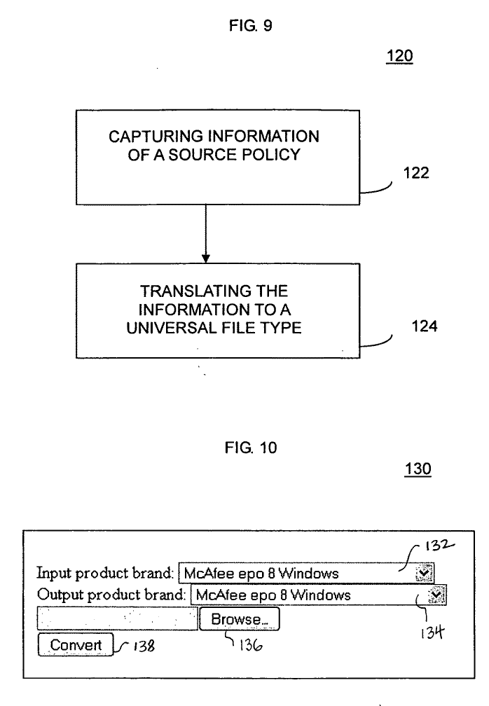

FIG. 9 shows a process 120 for translating information of a source policy to a universal file type. As shown in FIG. 9, process 120 begins by capturing 122 information of a source policy. The source policy may include any configuration information related to a system activity that warrant the attention of a security product such as read, write, execute, move, rename, and attribute change operations to disk or storage medium and/or network or interconnecting data transfer interfaces.

The information of a source policy may be captured 122 from the database 16 (FIG. 1), or may be uploaded by a user having administrative privileges. For example, a user may specify an existing source policy from a database by indicating a product type or the system 10 (FIG. 1) may receive a download from one of the sources 18, using which information of a policy is captured or obtained. Users, administrators, and other operators may be provided with different levels of permission. For example, an administrator may be assigned a level of permission to enable the administrator to upload policy configuration of a new product, while a user is assigned with a level of permission that allows conversion between uploaded policy configurations. Information of a policy may be captured using identifying data such as a descriptive identifier or attribute of the policy, a filename, a policy name, descriptive text, author information, permissions, and timestamps for creation, modification, and last access, etc.

Subsequent to capturing 122 the information, process 120 proceeds to translating 124 the information to a universal file type. The translating 124 may be implemented, for example, using .NET, Java®, and/or other solutions using which instances can be converted to a consistent or common format useable by various different security products, solutions and/or services. For example, a configuration item of a source policy is converted or translated into a format and used to execute operation(s) a policy configuration item of a target policy defined in a format different from the source policy.

The information translated to a universal file type may be used to trigger action(s) to be taken based on a detection or suspicion of a security threat including file system action(s), known prevention method(s) and defensive tactic(s) to be implemented, a contingent, including third-party executables and/or scripts. In addition, the universal file type may be used to set preferences including a succession of actions, conditional or subsequent actions, and all preferences for any defined actions that may be triggered.

FIG. 10 shows a GUI 130 for converting information of an input product to an output product. As shown in FIG. 10, the GUI 130 includes an option 132 for specifying an input product brand, an option 134 for selecting an output product brand, a browse button 136 for searching or browsing through products or information related thereto, and a convert button 138 for executing a conversion between policy configuration information of the input product brand to the output product brand.

FIG. 11 shows a layout 140 of normalized and brand policy items. As shown in FIG. 11, the layout 140 includes normalized policy item listing 142 and brand policy item listing 144. An item from the brand policy item listing 144 may be associated or mapped to an item in the normalized policy item listing 142. For example, a user may select or drag an item from a particular product such as McAfee® virus scan product, associate or drop the item with respect to a corresponding item in the normalized listing and specify a value for the item. Further, the normalized schema implemented by the system 10 (FIG. 1) may include multiple categories/elements including the categories of items illustrated in FIG. 11 but not limited thereto.

FIG. 11A shows a GUI 230 for managing information of normalized data field(s). As shown in FIG. 11A, a list of values (elements) 232b pertaining to a normalized policy item 232a are provided via the GUI 230. As an example, the list of values or elements 232b include Enabled, ScanMemory, ScanProcesses, RealTimeScan, ScanZipFiles, FirstAction, SecondAction, ScanNetwork, HaveExceptionDirs, ExceptionExts, ScanFloppy, ScanBootSectors, ShowVPIcon, ExceptionDirs, etc. A normalized data field may be managed by specifying applicable product information such as a product type 234. Further, values or elements of a normalized data field may be modified by adding a field with a field name 236 and a field type 238 specified, and/or adding a field value 240 having a field meaning 242 specified and by selecting an add value button 244. Information of the normalized data fields may be saved using a Save button 246.

FIG. 12 shows an exemplary record 150 of management and/or translation of policy items. As shown in FIG. 12, data structures are provided for normalized policy items (converted), brand policy item (source), policy types, products, adapters, and compliance. For example, an item of the normalized policy is associated with an item in the brand policy having items in a particular format. Further, data structure of the adapters maintaining data related to identifier, version, type, etc., may also be associated with or mapped to information of the products including but not limited to name, version, vendor, etc.

FIG. 13 shows a GUI 160 for creating a new compliance standard. The GUI 160 illustrates a compliance option 162 selected that enables a user to create a new compliance standard for comparing a setting or value of a policy to a setting or value of any other policy or standard. Information of a new compliance standard such as a product type 164 and a compliance name 166 may be indicated and a new compliance standard may be created by selecting a create button 168. As mentioned above, the system 10 (FIG. 1) may indicate or highlight information such as differences between a user's policy and another policy that complies with a given standard. In this case, the new compliance standard may be used as a baseline, for example, to maintain a security posture among multiple products and/or services.

FIG. 13A shows a GUI 170 for editing a compliance standard. As shown in FIG. 13A, compliance data 172 including a list of elements 174 of a normalized policy item are provided. Any of the element(s) 174 of the normalized policy item may be selected or unselected with corresponding values to modify the configuration of the compliance standard and information of the standard may be stored by selecting a save button 176. For example, element(s) corresponding to settings that are considered to important at a company may be set as a compliance standard and each product running at the company may be compared to the compliance standard to determine compliance.

FIG. 13B shows a GUI 180 for managing information of compliance standard(s). As shown in FIG. 13B, the GUI 180 may be used to sort 182 information of compliance standards by specifying a sort criteria such as product information, product type, version, etc. For example, a search of the information of compliance standards using “anti-virus” as the sort criteria results in “ani-virus compliance 1.” Further, using the GUI 180, a user may delete information via a delete button 188, modify information via an edit button 186, and create (or input) information using a create button 184.

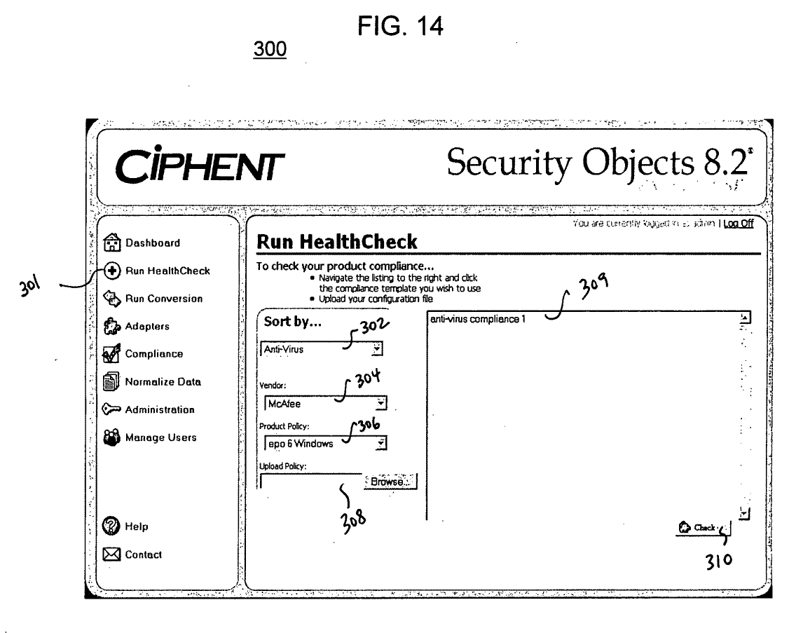

FIG. 14 shows a GUI 300 for running a healthcheck regarding a product. As mentioned above with respect to FIG. 5, a healthcheck option 301 may be selected for identifying configuration areas (or items) that need improvement. As shown in FIG. 14, the GUI 300 may be used to identify a product using sort criteria 302, identifying a vendor 304 and/or a product policy 306 and uploading a policy using a browse option 308. Once a product has been identified, a check button 310 may be selected to determine whether configuration item(s) or element(s) of a product satisfy a given threshold. For example, “anti-virus compliance standard 1” may be retrieved as a result 309 of identifying information of a product, and a health check may be run by comparing elements of the product with that of the compliance standard.

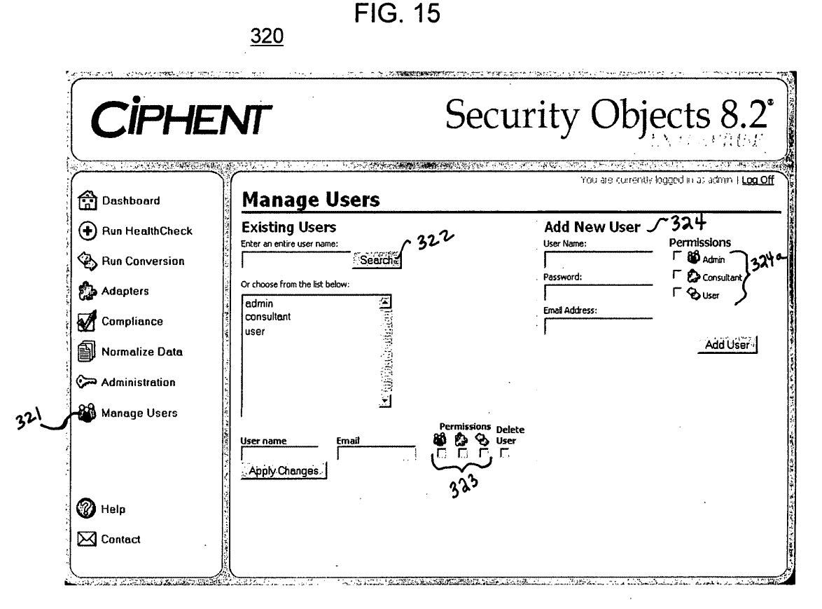

FIG. 15 shows a GUI 320 for managing information of users. As shown in FIG. 15, users may be managed by identifying (searching) 322 through existing users or adding new users 324 and setting permissions 323, 324a indicating privileges corresponding to each of the users. Based on a type and/or level of privilege assigned to a user, information or content of a security software, solution or service can be translated into a universal data type for use with any one of multiple applications developed by vendors including vendors that use different formats for defining configurations thereof. As mentioned above, the manage users option enables basic administration of users, systems and privileges associated therewith and may be utilized to monitor system resources, permissions, execution and/or instantiation of any application into a memory and specified and relevant procedures and practices thereof.

The disclosed system and method enables information of a source policy configuration to be obtained and translated into a universal data type useable with a target policy configuration in response to a request to migrate from a first security application to a second security application. The disclosed translation and/or management of policy configuration may be implemented even when policy configuration settings are defined using different language or instruction formats.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, the disclosed invention may be implemented as a host solution or enterprise software, and according to an aspect of the embodiments, any combination(s) of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method of translating information, comprising:
capturing information of a source policy configuration; and
translating the information into a universal data type useable with a target policy configuration.

2. The method according to claim 1, wherein at least one of said capturing or said translating is executed responsive to a user request to migrate from a first security application to a second security application.

3. The method according to claim 2, wherein said translating is executed automatically.

4. The method according to claim 1, wherein the source policy configuration is defined by a first vendor and the universal data type resulting from said translating is used to set a policy configuration item of a second vendor that is different from a policy item of the source policy configuration of the first vendor.

5. The method according to claim 1, wherein said translating comprises:
transforming the information into a set of normalized data elements;
mapping the set of normalized data elements into values for the target policy configuration; and
generating the target policy configuration based on content of the source policy configuration.

6. The method according to claim 1, wherein the source policy configuration is used to configure at least one of an antivirus application, an antispyware application, an endpoint and system encryption application, a host-data loss prevention application, a patch management application, a vulnerability management application, data security, data tagging, browser security, compliance management, or a host firewall application installed on a system.

7. The method according to claim 1, wherein the source policy configuration is used to implement at least one of host intrusion prevention or sensitive information control of a system.

8. The method according to claim 1, comprising:
converting the information back to a data element for the source policy configuration subsequent to said translating.

9. The method according to claim 1, wherein the source policy configuration is in an extensible markup language, includes registry value(s), database value(s), or configuration file(s), and said translating is executed using an adapter.

10. The method according to claim 5, comprising:
outputting data of multiple policy definition and configuration formats using said set of normalized data elements.

11. The method according to claim 1, comprising:
converting the universal data type into a policy value or configuration element of a security application specified in a migration process.

12. A system, comprising:
a user device running a security application based on original policy configuration settings;
a database having policy configuration files of security applications defined by multiple vendors;
a device having an application containing several adapters utilized to map the policy configuration files; and
a server translating the original policy configuration settings into a target policy configuration file for use by a specified one of security applications provided by a vendor among said multiple vendors.

13. The system according to claim 12, wherein at least one of said multiple vendors has a policy configuration format different from the policy configuration files of the multiple vendors.

14. The system according to claim 12, wherein the policy configuration files are used to provide a security service protecting and managing the user device or system, corresponding data, user(s), or dependencies.

15. The system according to claim 12, wherein a process of the security application running based on the original policy configuration file is integrated with a process of a security service defined by one of said security applications utilizing the target policy configuration file.

16. The system according to claim 12, wherein the original policy configuration file is specific to the security application.

17. A computer-readable medium embodying a program for causing a computer to execute operations, comprising:
retrieving a policy configuration file of a first security application;
transforming a value of the policy configuration file to a normalized field via the adapter;
creating a new policy configuration file based on the normalized field via the adapter; and
using the new policy configuration file with a second security application based on the policy configuration file of the first security application.

18. The computer readable medium according to claim 17, wherein said translating includes manipulating and parsing content of the policy configuration file.

19. The computer readable medium according to claim 17, comprising:
converting the information back to a value for the policy configuration file subsequent to said translating.

20. The computer readable medium according to claim 17, wherein said normalized field is utilized to execute an update to the configuration of the second security application.
